(19) United States
(12) Patent Application Publication
(10) Pub. No.: US 2025/0116439 A1
(43) Pub. Date: Apr. 10, 2025

(54) Refrigerant Piping, Method for Manufacturing Refrigerant Piping, Connection Structure for Refrigerant Piping, and Valve Device

(71) Applicant: Saginomiya Seisakusho, Inc., Tokyo (JP)

(72) Inventors: Hidetaka WATANABE, Saitama (JP); Masahiro MURATA, Saitama (JP); Ryo MITOME, Saitama (JP); Satoshi OKADA, Saitama (JP); Daiichiro KEMMOTSU, Saitama (JP)

(21) Appl. No.: 18/729,418

(22) PCT Filed: Oct. 19, 2022
(86) PCT No.: PCT/JP2022/038874

§ 371 Date: Jul. 16, 2024

(30) Foreign Application Priority Data
Jan. 17, 2022 (JP) 2022-005144

(51) Int. Cl. F25B 41/40; F16L 9/02; F25B 41/26

(52) U.S. Cl. CPC F25B 41/40; F16L 9/02; F25B 41/26

(57) ABSTRACT

To provide a refrigerant pipe, a manufacturing method of a refrigerant pipe, connection structure for refrigerant pipes, and a valve device that it is easy to perform connection by brazing even in a case in which the materials thereof are different from each other. A joint member consists of stainless steel, wherein a coat of copper or copper alloy by a metallic bond is formed on an inner circumferential surface or an outer circumferential surface in an end portion on at least one side in a longitudinal direction. Accordingly, even in the case in which the joint member itself consists of stainless steel, it is easy to connect with the connection target via the end portion on which the coat of copper or copper alloy is formed.

### TECHNICAL FIELD

The present invention relates to a refrigerant pipe, a manufacturing method of a refrigerant pipe, connection structure for refrigerant pipes, and a valve device.

### BACKGROUND ART

Conventionally, in an air conditioner such as a room air conditioner, during a cooling operation, refrigerant is circulated through a compressor, an outdoor heat exchanger, an expansion valve, and an indoor heat exchanger connected via refrigerant pipes to the compressor, and during a heating operation, the direction of the refrigerant circulation is reversed such that the refrigerant is circulated back to the compressor through the compressor, an indoor heat exchanger, the expansion valve, and the outdoor heat exchanger. In this manner, as a flow-path switching valve (a so-called four-way switching valve), which is a valve device that reverses the refrigerant circulation path, a slide-type switching valve that has a valve body which is provided inside the valve body to be slidably therein is widely used (For example, see Patent Document 1). Then, according to such air conditioner, the refrigerant pipes arranged inside the device and a joint member (refrigerant pipe) provided as a discharge pipe and a suction pipe of the slide-type switching valve are connected by brazing.

### CITATION LIST

### Patent Documents

Patent Document 1: JP 2004-125238A

### SUMMARY OF THE INVENTION

### Technical Problem

Then, according to the valve device (slide-type switching valve), generally, a main body thereof consists of the brass, and other members such as the joint member and the like consist of the copper. However, recently, due to the rapid rise in the price of the copper, a trend of using stainless steel is advancing to replace the copper, which has conventionally been used as the material of the joint member in the valve device, with the stainless steel. On the contrary, in the air conditioner in which the valve device is included, in consideration of the processing facilitation and the performance stability, the copper is still used as the material of the refrigerant pipes. Accordingly, since the material of the stainless-steel-made joint member of the valve device and the material of the copper-made refrigerant pipes of the air conditioner are different from each other, there is a problem that it is difficult to realize the connection by brazing as the convention solution.

Furthermore, regarding the brazing of the joint member of the valve device and the refrigerant pipes of the air conditioner, in a case of using the flux to ensure the wettability, since it takes time to remove the flux, conventionally such flux is not used. That is, since the flux is not used in addition to the fact that the materials of the refrigerant pipes including the stainless steel in the raw material and the joint member including the copper in the raw material are different from each other, it is significantly difficult to perform the brazing therebetween.

Accordingly, the present invention is made in consideration of the above-described circumstances, and an object of the present invention is to provide a refrigerant pipe that is easy to be connected by brazing even in a case in which the materials thereof are different from each other, a manufacturing method of a refrigerant pipe, connection structure for refrigerant pipes, and a valve device.

### Solution to Problem

A refrigerant pipe according to the present invention is a refrigerant pipe consisting of stainless steel and characterized in that a coat of copper or copper alloy by a metallic bond is formed on an inner circumferential surface or an outer circumferential surface in an end portion on at least one side in a longitudinal direction.

According to the present invention, even in the case in which the refrigerant pipe itself consists of the stainless steel, it is easy to connect it with a connection target via the end portion on which the coat of copper or copper alloy is formed by brazing.

At this time, according to the refrigerant pipe of the present invention, it is preferable that a coating member consisting of the copper or the copper alloy forming the coat is a sheet-shaped body and is arranged in a state of being rounded in a C shape. According to such a configuration, in a case in which the coating member is arranged on the inner circumferential surface of the end portion of the refrigerant pipe, the coating member is held by the inner circumferential surface of the refrigerant pipe due to an elastic force in an expanding direction from the state of being rounded in the C shape for maintaining the shape thereof, and in a case in which the coating member is arranged on the outer circumferential surface of the end portion of the refrigerant pipe, the coating member is held by the outer circumferential surface of the refrigerant pipe due to an elastic force for in a direction where the coating member is rounded in the C shape for maintaining the shape thereof such that it is possible to save the trouble of holding it with respect to the arrangement location by a spot welding or the like and it is easy to arrange the coating member. Also, joint portions of the end portions of the coating member facing each other are arranged to be apart with an interval therebetween such that in the portion where the interval is formed, the outer circumferential side and the inner circumferential side of the coating member are penetrated and gas and bubbles of the air and the like existing between the coating member and the wall of the refrigerant pipe can be removed.

Furthermore, according to the refrigerant pipe of the present invention, it is preferable that a coating member consisting of the copper or the copper alloy forming the coat is an annular cylindrical body. According to such a configuration, by expanding the cylindrical body of the coating member in an outer diameter direction or contracting the cylindrical body of the coating member in an inner diameter direction in response to the arrangement location, for example, it is possible to save the trouble of holding it with respect to the arrangement location by a spot welding or the like and it is easy to arrange the coating member.

In addition, in a case in which the coating member consisting of the copper or the copper alloy forming the coat is the sheet-shaped body or the cylindrical body, it is preferable that a slit is provided in the coating member in a circumferential direction or an axial direction thereof. According to such a configuration, at the location of the slit, the outer circumferential side and the inner circumferential side of the coating member are penetrated and gas and bubbles of the air and the like existing between the coating member and the wall of the refrigerant pipe can be removed. In addition, due to the slit, it is possible to eliminate the distortion that occurs during the heating in the metallic bond.

Furthermore, according to the refrigerant pipe of the present invention, it is preferable that a coating member consisting of the copper or the copper alloy forming the coat is a net-shaped body and is arranged in an annular shape or in a state of being rounded in a C shape. According to such a configuration, in a case in which the coating member is arranged in the state of being rounded in the C shape, the end portion of the refrigerant pipe is held by the elastic force of the coating member, and in a case in which the coating member is arranged in the annular shape, the coating member is held by expanding in the outer diameter direction or contracting in the inner diameter direction in response to the arrangement location such that for example, it is possible to save the trouble of holding it with respect to the arrangement location by a spot welding or the like and it is easy to arrange the coating member. Also, since the coating member overall includes the net-shaped holes penetrating the outer circumferential side and the inner circumferential side, it is possible to remove gas and bubbles of the air and the like existing between the coating member and the wall of the refrigerant pipe. In addition, due to the net-shaped holes, it is possible to eliminate the distortion that occurs during the heating in the metallic bond.

Also, according to the refrigerant pipe of the present invention, it is preferable that a coating member consisting of the copper or the copper alloy forming the coat is a band-shaped body with a cross section in a circular shape or a rectangular shape, and is spirally arranged along an axial direction. According to such a configuration, the coating member is held by the end portion of the refrigerant pipe due to the elastic force of the band-shaped coating member such that for example, it is possible to save the trouble of holding it with respect to the arrangement location by a spot welding or the like and it is easy to arrange the coating member. Also, in the coating member, fine gaps spirally penetrating the outer circumferential side and the inner circumferential side thereof are formed such that gas and bubbles of the air and the like existing between the coating member and the wall of the refrigerant pipe can be removed through the gaps. In addition, due to the fine gaps, it is possible to eliminate the distortion that occurs during the heating in the metallic bond.

Furthermore, according to the refrigerant pipe of the present invention, it is preferable that a coating member consisting of the copper or the copper alloy forming the coat is a ring-shaped body in a C shape or an annular shape, and a plurality of the coating member are provided along an axial direction so as to be adjacent to each other. According to such a configuration, in a case in which the ring-shaped coating member is arranged in a state of being rounded in the C shape, the coating member is held by the end portion of the refrigerant pipe due to the elastic force of the coating member, and in a case in which the coating member is arranged in the annular shape, since the coating member is held by expanding in the outer diameter direction or contracting in the inner diameter direction in response to the arrangement location such that for example, it is possible to save the trouble of holding it with respect to the arrangement location by a spot welding or the like and it is easy to arrange the coating member. Also, fine gaps penetrating the outer circumferential side and the inner circumferential side are formed between the adjacent coating members in a multi-layer shape such that it is possible to remove gas and bubbles of the air and the like existing between the adjacent coating members in the multi-layer shape and the wall of the refrigerant pipe through the gaps. In addition, due to the fine gaps in the multi-layer shape, it is possible to eliminate the distortion that occurs during the heating in the metallic bond.

Also, according to the refrigerant pipe of the present invention, it is preferable that a coating member consisting of the copper or the copper alloy forming the coat is a wire-shaped body, and is arranged in an annular shape or in a state of being rounded in a C shape. According to such a configuration, in a case in which the wire-shaped coating member is arranged in the state of being rounded in the C shape, the coating member is held by the end portion of the refrigerant pipe due to the elastic force of the coating member, and in a case in which the coating member is arranged in the annular shape, since the coating member is held by expanding in the outer diameter direction or contracting in the inner diameter direction in response to the arrangement location such that for example, it is possible to save the trouble of holding it with respect to the arrangement location by a spot welding or the like and it is easy to arrange the coating member.

Also, according to the refrigerant pipe of the present application, it is preferable that in a coating member consisting of the copper or the copper alloy forming the coat, a surface of a section orthogonal to an axial direction is formed in an uneven shape along a circumferential direction.

In addition, according to the refrigerant pipe of the present invention, it is preferable that the coat is formed to extend to an end surface in the end portion at the one side. According to such a configuration, the coat is provided not only on the surface (inner circumferential surface or outer circumferential surface) in contact with the surface (outer circumferential surface or inner circumferential surface) of the connection target in the refrigerant pipe, but also provided to extend the end surface of the refrigerant pipe such that in a case in which the material of the connection target is set as the copper or the copper alloy to be the same with that of the coat, it is easy to form a suitable fitting. Accordingly, it is possible to definitely ensure the airtightness of the portion where is joined without any gaps and processed by brazing and it is possible to further ensure the reliability of the connection.

A manufacturing method of a refrigerant pipe according to the present invention is a manufacturing method of a refrigerant pipe consisting of stainless steel, and the manufacturing method of a refrigerant pipe is characterized in heating copper or copper alloy to a temperature above a solidus temperature to cause the copper or the copper alloy into a semi-molten state in an environment in which an oxide coat is removable so as to form a coat of copper or copper alloy with respect to an inner circumferential surface or an outer circumferential surface in an end portion on at least one side of a longitudinal direction of the refrigerant pipe. According to the present invention, even in the case in which the refrigerant pipe itself consists of the stainless steel, the coat of copper or copper alloy is formed on the inner circumferential surface or the outer circumferential surface of the connecting end portion such that it is easy to perform the connection by brazing.

At this time, according to the manufacturing method of a refrigerant pipe of the present invention, it is preferable that the environment in which an oxide coat is removable is a hydrogen reduction furnace. According to this method, due to the hydrogen reduction furnace used in the connection of the refrigerant pipe, it is possible to remove the oxide coat while forming the coat of copper or copper alloy such that it is possible to reduce the man-hours.

Also, according to the manufacturing method of a refrigerant pipe according to the present invention, it is preferable that the coat of copper or copper alloy is formed by laser irradiation. According to such method, it is possible to directly form the coat of copper or copper alloy while removing the oxide coat by the laser irradiation.

A connection structure for refrigerant pipes according to the present invention is a connection structure for refrigerant pipes where a first refrigerant pipe and a second refrigerant pipe are connected by brazing, the connection structure for refrigerant pipes is characterized in that the first refrigerant pipe consists of stainless steel, and a coat of copper or copper alloy by metallic bond is formed on an inner circumferential surface or an outer circumferential surface of an end portion of the first refrigerant pipe at the second refrigerant pipe side, and the second refrigerant pipe consists of the copper or the copper alloy, or the coat of copper or copper alloy by metallic bond is formed on an inner circumferential surface or an outer circumferential surface of an end portion of the second refrigerant pipe at the first refrigerant pipe side. According to the present invention, even in the case in which the first refrigerant pipe consists of the stainless steel, there is the coat of copper or copper alloy formed on the inner circumferential surface or the outer circumferential surface of the end portion of the second refrigerant pipe due to metallic bond such that it is easy to connect the first refrigerant pipe with the second refrigerant pipe, as the connection target, which consists of copper or copper alloy, or having the coat of copper or copper alloy formed by metallic bond on the outer circumferential surface or the inner circumferential surface of the end portion at the first refrigerant pipe side.

Furthermore, according to the connection structure for refrigerant pipes of the present invention, it is preferable that the coat is formed to extend to an end surface in an end portion of the first refrigerant pipe at the second refrigerant pipe side and, in a case in which the second refrigerant pipe does not consist of the copper or the copper alloy, the coat is formed to extend to an end surface of an end portion of the second refrigerant pipe at the first refrigerant pipe side. According to such a configuration, the coat is not only provided on the surfaces in contact with each other in both of the first refrigerant pipe and the second refrigerant pipe, that is, the coat is not only provided on the surfaces (outer circumferential surface or inner circumferential surface) of the end portions at the connection target side, but also the coat is provided to extend to the end surfaces of the end portions at the connection target side such that in a case in which the material of the second refrigerant pipe as the connection target of the first refrigerant pipe or the coat formed in the end portion at the first refrigerant pipe side is set as the copper or copper alloy that is the same with that of the coat of the first refrigerant pipe, it is easy to form the suitable fitting. Accordingly, it is possible to definitely ensure the airtightness of the portion where is joined without any gaps and processed by brazing and it is possible to further ensure the reliability of the connection.

A valve device according to the present invention is a valve device including a valve main body to which a joint member is connected, the valve device is characterized in that any one of the above-described refrigerant pipes is used as the joint member. According to the present invention, similar to the above-described aspects, even in a case in which the joint member consists of the stainless steel, the coat of copper or copper alloy is formed by metallic bond on the inner circumferential surface or the outer circumferential surface in the end portion at the connection side of the joint member such that it is possible to easily connect it with the refrigerant pipe as the connection target by brazing. In addition, the similar effects with each of the above-described refrigerant pipes can be achieved.

### Effect of the Invention

According to the refrigerant pipe, the manufacturing method of a refrigerant pipe, the connection structure for refrigerant pipes, and the valve device of the present inventio, it is easy to realize the connection by using the brazing even in the case in which the materials thereof are different from each other.

### BRIEF DESCRIPTION OF THE DRAWINGS

FIG. 1 is a sectional view showing a slide-type switching valve according to an embodiment.

FIG. 2A is a sectional view in which a coating member is arranged on an inner circumferential surface to show an end portion of a joint member before heating that is provided in the slide-type switching valve of FIG. 1.

FIG. 2B is a sectional view showing an enlarged view of a main portion thereof to show the end portion of the joint member before heating that is provided in the slide-type switching valve of FIG. 1.

FIG. 3A is a sectional view in which the coating member is arranged on the inner circumferential surface to show the end portion of a joint member after heating that is provided in the slide-type switching valve of FIG. 1.

FIG. 3B is a sectional view showing an enlarged view of the main portion thereof to show the end portion of the joint member after heating that is provided in the slide-type switching valve of FIG. 1.

FIG. 4A is a sectional view taken along an axial direction showing the coating member of FIG. 2A and FIG. 2B.

FIG. 4B is a front view that is viewed from a direction orthogonal to the axial direction for showing the coating member of FIG. 2A and FIG. 2B.

FIG. 4C is an exploded view for showing the coating member of FIG. 2A and FIG. 2B.

FIG. 5 is an enlarged sectional view of a main portion showing a connection state between the joint member and the refrigerant pipe in the slide-type switching valve.

FIG. 6A is a sectional view showing a state before heating in which a coating member is arranged on an outer circumferential surface to show an end portion of a joint member according to a modification example.

FIG. 6B is a sectional view showing a state after heating in which the coating member is arranged on the outer circumferential surface to show the end portion of the joint member according to the modification example.

FIG. 7A is a sectional view taken along an axial direction showing the coating member of FIG. 6A and FIG. 6B.

FIG. 7B is a front view that is viewed from a direction orthogonal to the axial direction showing the coating member of FIG. 6A and FIG. 6B.

FIG. 7C is an exploded view showing the coating member of FIG. 6A and FIG. 6B.

FIG. 8 is an enlarged sectional view of a main portion showing a connection state between the joint member and the refrigerant pipe of FIG. 6A and FIG. 6B.

FIG. 9A is a sectional view taken along an axis showing a state in which a cylindrical body of a coating member is arranged on an inner circumferential surface of an end portion of a joint member according to a modification example.

FIG. 9B is a front view that is viewed from a direction orthogonal to the axial direction showing the state in which the cylindrical body of the coating member is arranged on the inner circumferential surface of the end portion of the joint member according to the modification example.

FIG. 10 is a sectional view showing a state in which a slit in a circumferential direction is formed in a coating member that is arranged on an inner circumferential surface of an end portion of a joint member according to a modification example.

FIG. 11 is a sectional view showing a state in which a slit along an axial direction is formed in a coating member that is arranged on an inner circumferential surface of an end portion of a joint member according to a modification example.

FIG. 12 is a sectional view showing a state in which a net-shaped body of a coating member is arranged on an inner circumferential surface of an end portion of a joint member according to a modification example.

FIG. 13 is a sectional view showing a state in which a band-shaped body of a coating member with a rectangular section is spirally arranged on an inner circumferential surface of an end portion of a joint member according to a modification example.

FIG. 14 is a sectional view showing a state in which a band-shaped body of a coating member with a circular section is spirally arranged on an inner circumferential surface of an end portion of a joint member according to a modification example.

FIG. 15A is a sectional view showing a state in which a wire-shaped body of a coating member is arranged on an inner circumferential surface of an end portion of a joint member according to a modification example.

FIG. 15B is a sectional view showing the state in which the wire-shaped body of the coating member is arranged on the inner circumferential surface of the end portion of the joint member according to the modification example.

FIG. 16A is a cross-sectional view taken along an axis showing a coating member in which a surface of a cylindrical body is formed in an uneven shape according to a modification example.

FIG. 16B is a front view that is viewed from a direction orthogonal to the axial direction showing the coating member in which the surface of the cylindrical body is formed in the uneven shape according to the modification example.

FIG. 17A is a description view showing a state in which a coat is being formed by laser irradiation to show an end portion of a joint member according to a modification example.

FIG. 17B is a description view showing a state in which the coat has been formed after the laser irradiation to show the end portion of the joint member according to the modification example.

### DESCRIPTION OF EMBODIMENTS

Hereinafter, an embodiment of a refrigerant pipe, a manufacturing method of a refrigerant pipe, connection structure for refrigerant pipes, and a valve device will be described in details by referring to figures.

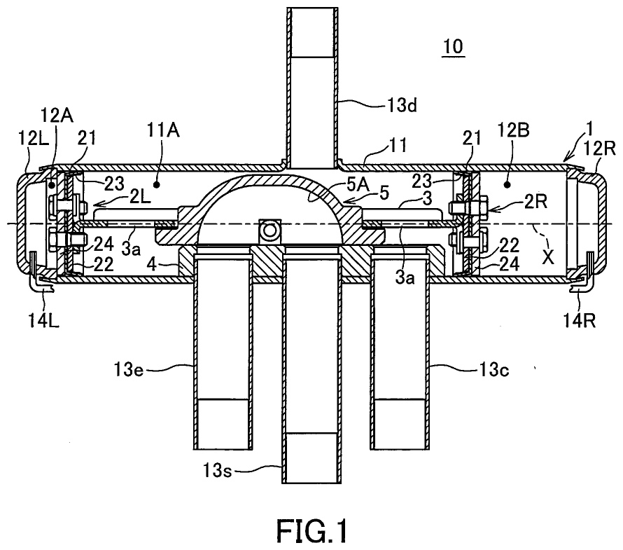

As shown in FIG. 1, a four-way switching valve (slide-type switching valve) 10 according to the present embodiment includes a pair of pistons 2L, 2R, a connection plate 3, a valve seat 4, and a valve body 5 in a valve housing 1 as a “valve main body”.

The valve housing 1 is configured from a cylindrical portion 11 in a cylindrical shape and made of metal such as stainless steel and the like, and two cap portions 12L, 12R made of metal such as the stainless steel and the like. Each of the cap portions 12L, 12R is attached to the cylindrical portion 11 so as to block an end portion of the cylindrical portion 11. Also, the central axis of the cylindrical portion 11 and the cap portions 12L, 12R becomes the axis X of the valve housing 1. A pair of pistons 2L, 2R are arranged to be opposite to each other to be reciprocatively movable while pressing a packing 21 onto an inner circumferential surface of the cylindrical portion 11. Accordingly, due to the two pistons 2L, 2R, the inside of the valve housing 10 is partitioned into a central hyperbaric chamber 11A, and two of a first operating chamber 12A and a second operating chamber 12B on both sides of the central hyperbaric chamber 11A. The connection plate 3 consists of a metal plate, and the connection plate 3 is interposed between the pistons 2L, 2R so as to arranged on the axis X of the valve housing 1 while the connection plate 3 holds the valve body 5 in the center thereof. Also, a through hole 3a is formed in the connection plate 3. Then, when the pistons 2L, 2R move, the valve body 5 slides on the valve seat 4 in conjunction with the connection plate 3 and stops at predetermined left and right positions.

The valve seat 4 is provided and arranged in an intermediate portion inside the cylindrical portion 11, and a D joint pipe 13d as a joint member that opens inside the cylindrical portion 11 according to the present embodiment is attached to a position being opposite to the valve seat 4 of the intermediate portion of the cylindrical portion 11. Also, an E joint pipe 13e, an S joint pipe 13s, and a C joint pipe 13c as the joint members that are the refrigerant pipes according to the present embodiment are arranged in a straight line along the axial direction X of the valve housing 1 and attached to the valve seat 4. Inside the valve body 5, a bowl-shaped concave portion 5A is formed at the inner side thereof. Then, the valve body 5 is configured to, at a position of an end portion at the left side of FIG. 1, conduct the S joint pipe 13s and the E joint pipe 13e by the bowl-shaped concave portion 5A. At this time, the C joint pipe 13c is mainly conducted to the D joint pipe 13d via the through hole 3a of the connection plate 3 inside the hyperbaric chamber 11A. Also, the valve body 5 is configured to, at a position of an end portion at the right side of FIG. 1, conduct the S joint pipe 13s and the C joint pipe 13c by the bowl-shaped concave portion 5A. At this time, the E joint pipe 13e is mainly conducted to the D joint pipe 13d via the through hole 3a inside the hyperbaric chamber 11A.

Here, the slide-type switching valve 10 according to the present embodiment is provided in a refrigeration cycle that is not shown in figures, for example. Also, as the refrigeration cycle, a general refrigeration cycle can be widely adopted such that the figures are omitted here for convenience.

In the corresponding refrigeration cycle, the D joint pipe 13d is connected to the discharge port of the compressor, and the S joint pipe 13s is connected to a suction port of the compressor. The C joint pipe 13c is connected to an outdoor heat exchanger, and the E joint pipe 13e is connected to an indoor heat exchanger. The outdoor heat exchanger and the indoor heat exchanger are connected via a throttling device. The refrigeration cycle is configured by a path from this C joint pipe 13c to the outdoor heat exchanger, the throttling device, the indoor heat exchanger and the E joint pipe 13e, and a path from the S joint pipe 13s to the compressor and the D joint pipe 13d. Also, in the refrigerant in the refrigeration cycle, in order to protect the compressor and other devices, a small amount of refrigeration oil is contained.

A pilot valve is connected to the slide-type switching valve 10. The pilot valve, for example, has the same structure with that of the slide-type switching valve 10 and configured to move the valve body due to an electromagnetic actuator so as to switch the flow paths. Also, this pilot valve switches the connection destination of the pipe communicating with the S joint pipe 13s of the slide-type switching valve 10 that is connected to the suction port of the compressor between a pressure introduction pipe 14L communicating with the first operation chamber 12A at the left side of the slide-type switching valve 10 and a pressure introduction pipe 14R communicating with the second operation chamber 12B at the right side thereof, and at the same time, the pilot valve switches the connection destination of the pipe communicating with the D joint pipe 13d of the slide-type switching valve 10 that is connected to the suction port of the compressor between the pressure introduction pipe 14R and the pressure introduction pipe 14L. Accordingly, due to the pressure difference between the pressure of the first operation chamber 12A in which the suction pressure or the discharge pressure of the compressor is introduced and the pressure of the second operation chamber 12B at the opposite side, the pistons 2L, 2R, the connection plate 3 and the valve body 5 are moved along the axis X of the valve housing 1, and the position of the valve body 5 is switched to switch the flow paths of the refrigeration cycle.

According to the above-described configuration, the refrigerant with the high-pressure that is pressed by the compressor flows into the main valve chamber 11A from the D joint pipe 13d, in the state of cooling operation, the high-pressure refrigerant flows from the C joint pipe 13c into the outdoor unit. Also, in the heating operation in which the valve body 5 is switched, the refrigerant with the high-pressure flows from the E joint pipe 13e into the indoor unit. That is, during the cooling operation, the refrigerant discharged from the compressor circulates along the C joint pipe 13c, the outdoor heat exchanger, the throttling device, the indoor heat exchanger, and the E joint pipe 13e in this sequence, wherein the outdoor heat exchanger functions as a condenser while the indoor heat exchanger functions as an evaporator such that the cooling operation is achieved. Also, during the heating operation, the refrigerant is reversely circulated, the indoor heat exchanger functions as the condenser, and the outdoor heat exchanger functions as the evaporator such that the heating operation is achieved.

Each of the pistons 2L, 2R of the slide-type switching valve 10 has a mirror-symmetrical structure, as shown in FIG. 1. Each of the pistons 2L, 2R includes a packing 21, a fixed disc 22 fixed to the connection plate 3, a leaf spring 23, and a disc-shaped stopper plate 24. These packing 21, fixed disc 22, leaf spring 23, and the stopper plate 24 are arranged coaxially with the axis X as the center and integrally fixed by rivets, and the integrated pistons 2L, 2R are fixed to the connection plate 3 by bolts.

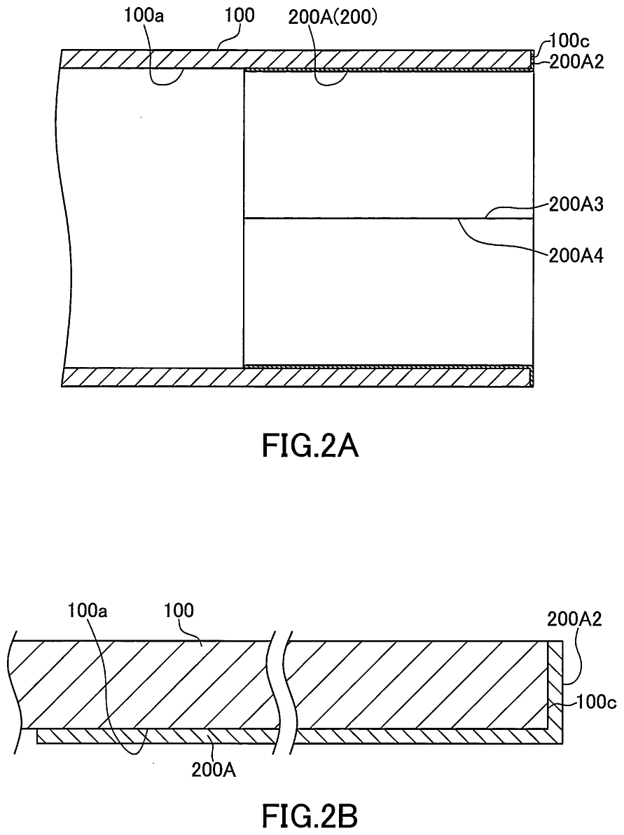

Hereinafter, the D joint pipe 13d, the E joint pipe 13e, the S joint pipe 13s, and the C joint pipe 13c as the joint members that are the refrigerant pipes according to the present embodiment and attached to the slide-type switching valve 10 with the above-described configuration will be described. Also, in the following description, these D joint pipe 13d, E joint pipe 13e, S joint pipe 13s, and C joint pipe 13c are collectively referred to as the joint member 100. Also, in the following description, with respect to the joint member 100, a case in which the coat 200 that will be described below is formed on an inner circumferential surface thereof and a case in which the coat 200 is formed on an outer circumferential surface will be described in sequence by using FIG. 2A to FIG. 5 and FIG. 6A to FIG. 8, respectively.

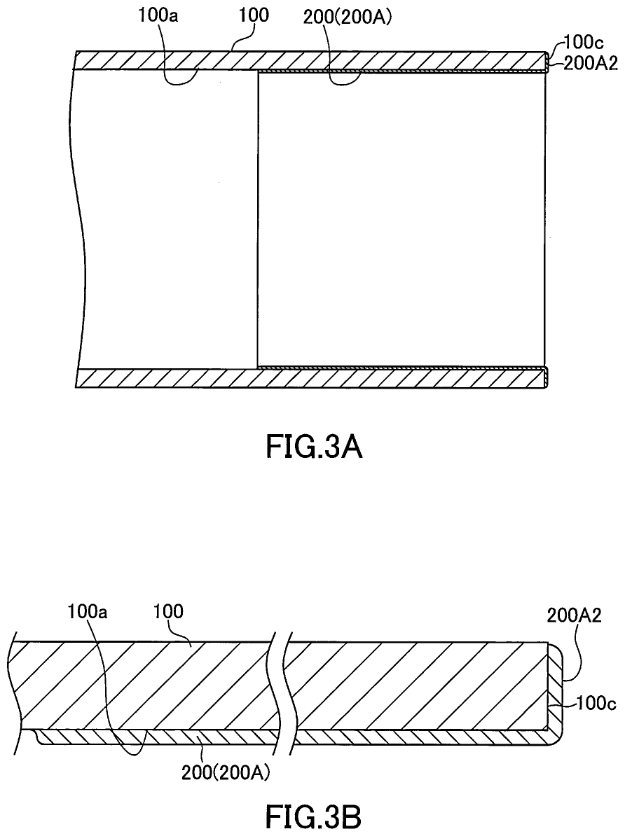

As shown in FIG. 2A, FIG. 2B, FIG. 3A, FIG. 3B, the joint member 100 as the refrigerant pipe according to the present embodiment consists of the stainless steel, and a sheet-shaped coat 200 consisting of copper or copper alloy (here, referring to the phosphor bronze containing tin) by metallic bond is formed on an inner circumferential surface 100a in an end portion on at least one side in the longitudinal direction. The coat 200 is formed across a wider range than a length where the refrigerant pipe 60 is inserted into the joint member 100. To describe in details, the coat 200 is formed across a range where the brazing strength with the refrigerant pipe connected to the joint member 100 can be fully satisfied, more specifically, the coat 200 is formed in a range within a length from an end surface of the joint member 100 that is equal to or larger than a thickness of the joint member 100, it is preferable that the coat 200 is formed in a range within the length that is equal to or larger than half of the inner diameter of the joint member 100, and it is more preferable that the coat 200 is formed in a range within the length that is equal to or larger than the inner diameter of the joint member 100. The coat 200 consists of a sheet-shaped body of a coating member 200A described below, and a boundary with the inner circumferential surface 100a of the joint member 100 is formed by the metallic bond that is heated to a temperature above a solidus temperature of the phosphor bronze. The heating temperature may be set to the limit temperature at which phosphor bronze melts (near the liquidus temperature) to make it into a semi-molten state by heating. In the case in which the heating temperature is set to such a temperature, it is possible to improve the adhesion characteristic of the coating member 200A to the joint member 100 such that the coat 200 can be uniformly formed on the joint member 100. Also, the coating member 200A is melted and fixed to form the coat 200 such that with respect to the joint member 100, compared with the case in which a cylindrical body of copper or copper alloy is fixed by brazing or the like, the peeling of the coat 200 from the joint member 100 due to thermal expansion and thermal contraction is unlikely to occur. FIG. 2A, FIG. 2B show a state of the joint member 100 in which the coating member 200A is arranged before heating, and FIG. 3A, FIG. 3B show a state of the joint member 100 in which the coating member 200A is arranged after heating, that is, to show a state in which the coat 200 has been formed.

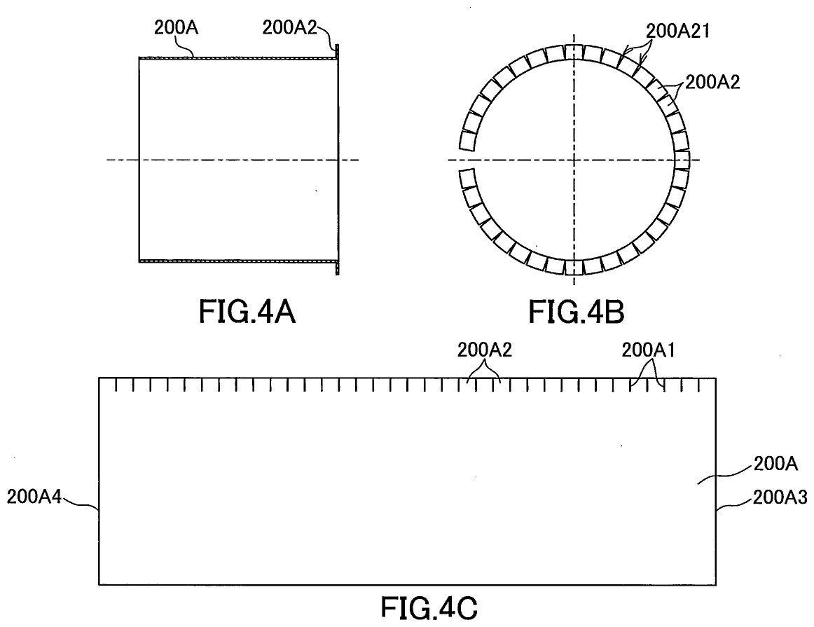

Here, as shown in FIG. 4A, FIG. 4B, FIG. 4C, such coat 200 is configured by the sheet-shaped body of coating member 200A in a form of strips with a thickness of 0.04 mm to 0.2 mm. A plurality of notches 200A1 being adjacent to each other are provided in the longitudinal direction at a location arranged in an end portion of the coating member 200A on the side of the opening of the joint member 100. Accordingly, when the coating member 200A is rounded in the C shape, by being bent outwardly in the diameter direction as a flange portion 200A2, when the coating member 200A is arranged in the opening end portion of the joint member 100, it is easy to perform the positioning of the coating member 200A with respect to this opening end portion.

As shown in FIG. 2A and FIG. 2B, the coating member 200A with such configuration is arranged on the inner circumferential surface 100a in the end portion on one side of the longitudinal direction of the joint member 100 in a state of being rounded in the C shape. At this time, the end portion 200A3 and the end portion 200A4 of the coating member 200A that are opposite to each other may be arranged in a state of being in contact with each other, or arranged to be apart from each other with an interval therebetween.

Then, the joint member 100 with the coat 200 is manufactured by the following steps. That is, in the state in which the coating member 200A is arranged in the end portion of the joint member 100 as described above, under an environment where the oxide coat is removable, for example, in the hydrogen reduction furnace, the coating member 200A is heated to a temperature near the melting point that is above the solidus temperature to cause the coating member 200A into a semi-molten state. Accordingly, as shown in FIG. 3A and FIG. 3B, with respect to the inner circumferential surface 100a of the joint member 100, although there are some portions where the thickness becomes slightly thinner from that of the coating member 200A before heating, generally, the uniform coat 200 with the thickness of about 0.04 mm to 0.2 mm, preferably about 0.08 mm to 0.1 mm is formed. In this manner, with respect to the inner circumferential surface 100a of the end portion of the joint member 100, the coat 200 is firmly fixed due to metallic bond. At this time, each end surface of the coating member 200A is chamfered by the heat treatment into an R shape with rounded corners.

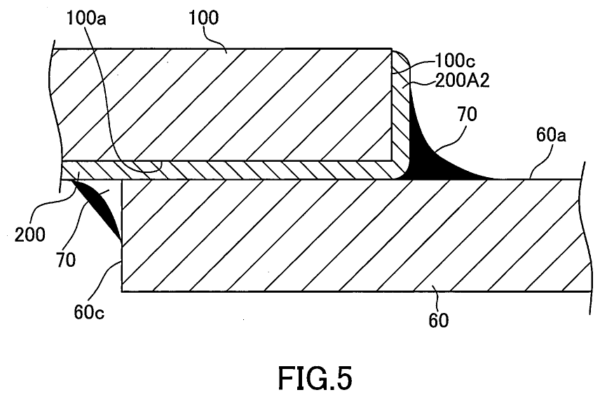

According to the joint member 100 formed in this manner and made of the stainless steel with the coat 200 that is made of the phosphor bronze, as shown in FIG. 5, even in a case in which the refrigerant pipe 60 is made of copper or copper alloy, wherein the refrigerant pipe 60 is included in the refrigeration cycle which is connected to the side of the inner circumferential surface 100a of the joint member 100 and not shown in figures, it is easy to perform the connection by brazing. At this time, since the coat 200 made of the phosphor bronze is provided not only on the surface (in this case, the inner circumferential surface 100a) in contact with the outer circumferential surface 60a of the refrigerant pipe 60 of the joint member 100, but also provided to extend to the end surface 100c of the joint member 100, in the case in which the material of the refrigerant pipe 60 is copper or copper alloy that is set to be the same with that of the coat 200, it becomes easy to suitably form the fillet 70. Accordingly, it is possible to perform the joining without any gaps to definitely secure the airtightness of the brazed portion.

Accordingly, it is possible to further ensure the reliability of the connection of the joint member 100 and the refrigerant pipe 60. Also, similarly, on the side of the end surface 60c of the refrigerant pipe 60, the coat 200 made of the phosphor bronze is provided on the inner circumferential surface 100a of the joint member 100 across a wider range than the length where the refrigerant pipe 60 is inserted into the joint member 100, the coat 200 is formed on the tip end side than the end surface 60c of the refrigerant pipe 60. Accordingly, in the case in which the material of the refrigerant pipe 60 is copper or copper alloy that is set to be the same with that of the coat 200, it becomes easy to form a suitable fillet between the end surface 60c and the inner circumferential surface 100a of the joint member 100. Accordingly, it is possible to perform the joining without any gaps to definitely secure the airtightness of the brazed portion, and further ensure the reliability of the connection of the joint member 100 and the refrigerant pipe 60.

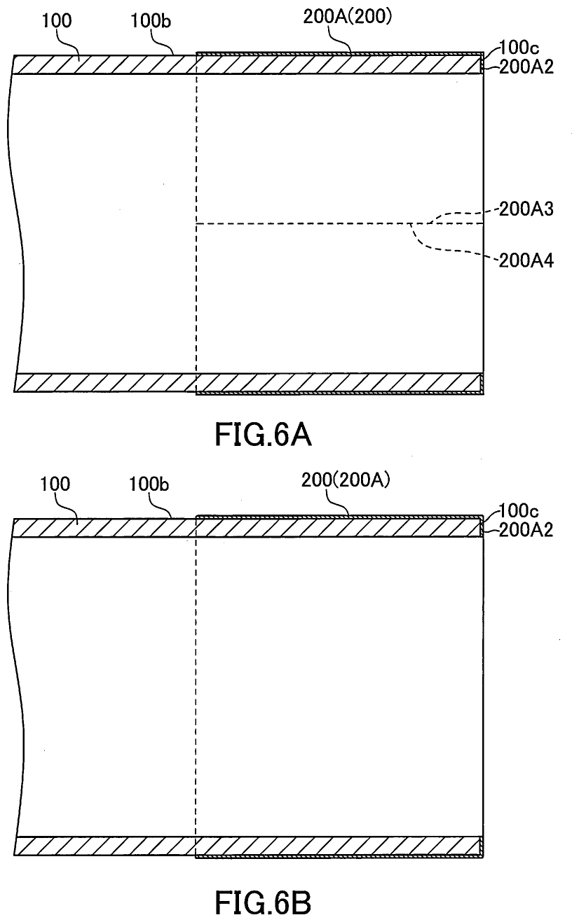

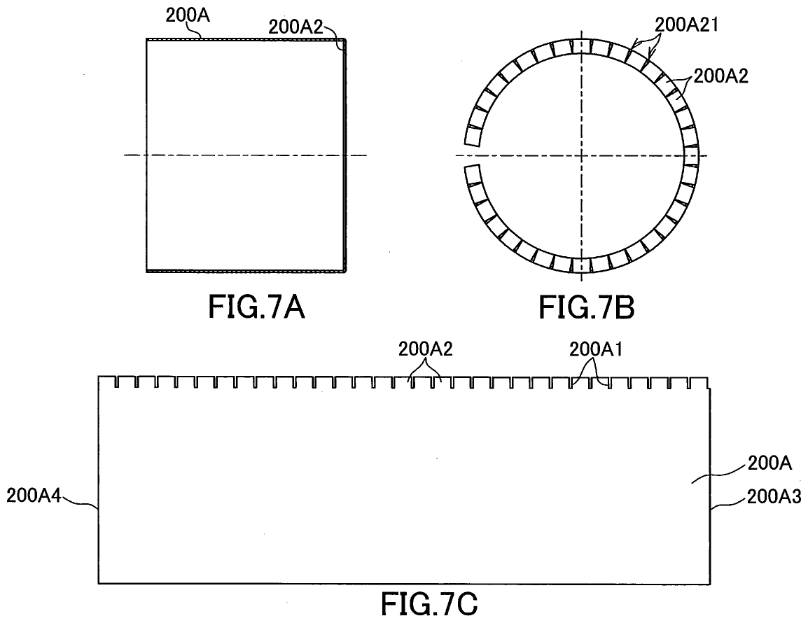

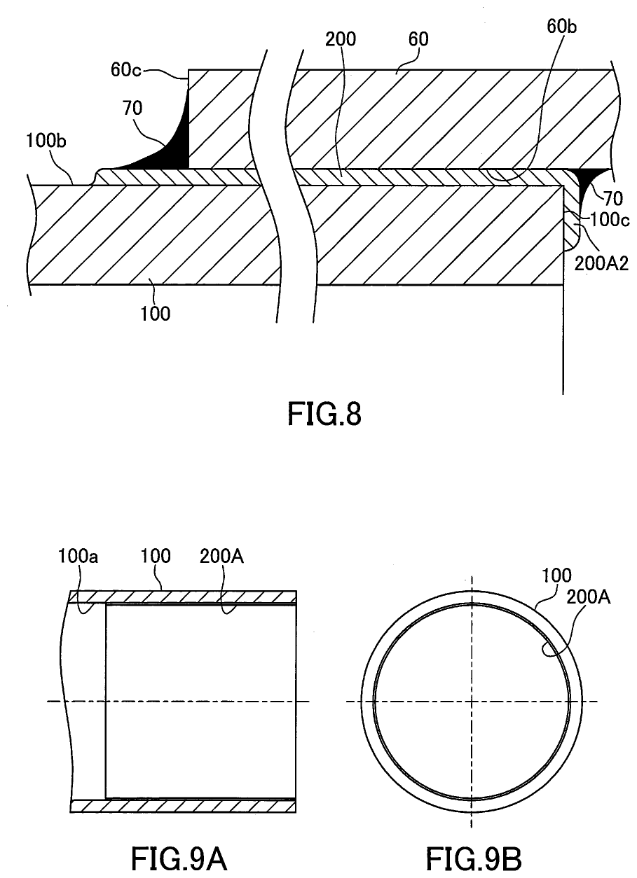

Hereinbefore, it is noted that the case in which the coat 200 is provided on the inner circumferential surface 100a of the joint member 100 has been described, as shown in FIG. 6A and FIG. 6B in which the portions corresponding to that in FIG. 2A and FIG. 3A are designated with the same reference signs, the coat 200 may be provided on the outer circumferential surface 100b of the joint member 100. In this case, as shown in FIG. 7A, FIG. 7B, FIG. 7C in which the portions corresponding to that in FIG. 4A, FIG. 4B, FIG. 4C are designated with the same reference signs, the coating member 200A consists of the coat 200 is configured in almost the same manner except for the point where the shape of the notches 200A1 is slightly different. Also, in the case in which the coat 200 is provided on the outer circumferential surface 100b of the joint member 100, the coat 200 is formed across a wider area than a length where the joint member 10 is inserted into the refrigerant pipe 60. To describe in details, the coat 200 is formed across a range where the brazing strength with the refrigerant pipe connected to the joint member 100 can be fully satisfied, more specifically, the coat 200 is formed in a range within a length from the end surface of the joint member 100 that is equal to or larger than the thickness of the joint member 100, it is preferable that the coat 200 is formed in the range within the length that is equal to or larger than half of the inner diameter of the joint member 100, and it is more preferable that the coat 200 is formed in the range within the length that is equal to or larger than the inner diameter of the joint member 100. The shape of the notches 200A1 is formed such that the flange portions 200A2 do not overlap each other in response to the difference between the case in which the flange portion 200A2 is bent outwardly in the diameter direction or the flange portion 200A2 is bent inwardly in the diameter direction when being bent in the C shape. According to the joint member 100 having the coat 200 that is formed by the metallic bond as described above, as shown in FIG. 8 in which the portions corresponding to that in FIG. 5 are designated with the same reference signs, even in the case in which the refrigerant pipe 60 connected to the side of the outer circumferential surface 100b of the joint member 100 is made of copper or copper alloy, it is easy to connect by using the brazing. At this time, since the coat 200 made of the phosphor bronze is provided not only on the surface (in this case, the outer circumferential surface 100b) in contact with the inner circumferential surface 60b of the refrigerant pipe 60 of the joint member 100, but also provided to extend to the end surface 100c of the joint member 100, in the case in which the material of the refrigerant pipe 60 is copper or copper alloy that is set to be the same with that of the coat 200, it becomes easy to suitably form the fillet 70. Accordingly, it is possible to perform the joining without any gaps to definitely secure the airtightness of the brazed portion. Accordingly, it is possible to further ensure the reliability of the connection of the joint member 100 and the refrigerant pipe 60. Also, similarly, on the side of the end surface 60c of the refrigerant pipe 60, the coat 200 made of the phosphor bronze is provided on the outer circumferential surface 100b of the joint member 100 across a wider range than the length where the refrigerant pipe 60 is inserted into the joint member 100, the coat 200 is formed on the tip end side than the end surface 60c of the refrigerant pipe 60. Accordingly, in the case in which the material of the refrigerant pipe 60 is copper or copper alloy that is set to be the same with that of the coat 200, it becomes easy to form a suitable fillet between the end surface 60c and the outer circumferential surface 100b of the joint member 100. Accordingly, it is possible to perform the joining without any gaps to definitely secure the airtightness of the brazed portion, and further ensure the reliability of the connection of the joint member 100 and the refrigerant pipe 60.

According to the present embodiment, the case in which the joint member 100 as the refrigerant pipe and the refrigerant pipe 60 made of copper or copper alloy are connected with each other has been described; however, the connection target of the joint member 100 is not limited to the refrigerant pipe made of copper or copper alloy, and similar to the case of the joint member 100, the connection target may be joint members that are made of metal such as the stainless steel or the iron and have the coat 200 of cooper or copper alloy on the inner circumferential surface or the outer circumferential surface of the end portion at the connection side. It is preferable that the material of the refrigerant pipe having the coat 200 is a metal with a higher melting point than that of copper or copper alloy.

According to the above-described embodiment, the following effects can be achieved. That is, even in a case in which the joint member 100 itself consists of the material including the stainless steel, since the coat 200 of copper or copper alloy by the metallic bond is formed on the inner circumferential surface 100a or the outer circumferential surface 100b of the end portions to be connected with each other, it is easy to connect them by the brazing.

At this time, in the joint member 100, it is preferable that the coating member consisting of copper or copper alloy forming the coat 200 is the sheet-shaped body and is arranged in the state of being rounded in the C shape. According to such a configuration, in the case in which the coating member 200A is arranged on the inner circumferential surface in the end portion of the joint member 100, the sheet-shaped body of the coating member 200A, that is elastically deformed to the extent that the inner diameter of the coating member 200A becomes smaller than the inner diameter of the joint member 100, is held by the inner circumferential surface of the refrigerant pipe due to the elastic force for maintaining the shape in the direction of expanding from the state of being rounded in the C shape, and in the case in which the coating member 200A is arranged on the outer circumferential surface in the end portion of the refrigerant pipe, the coating member 200A, that is plastically deformed to the extent that the inner diameter of the coating member 200A becomes smaller than the outer diameter of the joint member 100, is held by the outer circumferential surface of the refrigerant pipe due to the elastic force for maintaining the shape in the direction of being rounded into the C shape such that it is possible to save the trouble of holding the coating member 200A with respect to the arrangement location by the spot welding or the like and it is easy to arrange the coating member 200A. Also, the joint portions of the end portions 200A3, 200A4 of the coating member 200A facing each other are arranged to be apart with an interval therebetween such that in the portion where the interval is formed, the outer circumferential side and the inner circumferential side of the coating member 200A are penetrated and gas and bubbles of the air and the like existing between the coating member 200A and the wall (the inner circumferential surface 100a or the outer circumferential surface 100b) of the joint member 100 can be removed. Also, in the case in which the coating member 200A is arranged on the inner circumferential surface 100a of the joint member 100, due to the thermal expansion occurred during the heat treatment, the adhesion characteristic of the coating member 200A with respect to the inner circumferential surface 100a of the joint member 100 is further improved. This aspect also applies to other modification examples described below.

It is noted that the present invention is not limited to the above-described embodiments and includes other configurations that can achieve the object of the present invention, and the present invention also includes modifications as shown below.

For example, as shown in FIG. 9A and FIG. 9B, regarding the joint member 100 as the refrigerant pipe according to the present invention, it is preferable that the coating member 200A consisting of the copper or copper alloy forming the coat 200 is the annular cylindrical body. According to such configuration, by performing the plastic processing for expanding the cylindrical body of the coating member 200A outwardly in the diameter direction or performing the plastic processing for contracting the cylindrical body of the coating member 200A inwardly in the diameter direction in response to the arrangement location, it is possible to save the trouble of holding it with respect to the arrangement location by a spot welding or the like and it is easy to arrange the coating member.

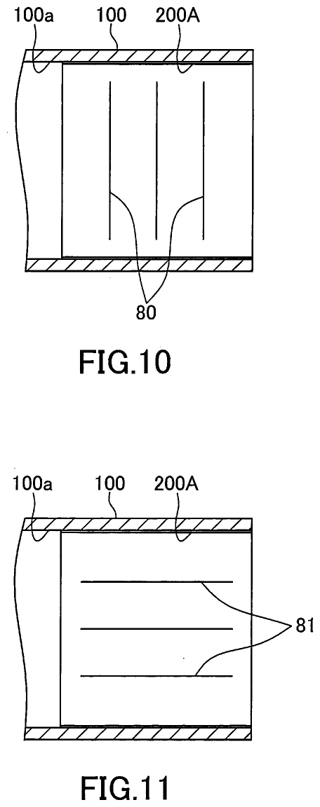

In addition, as shown in FIG. 10 and FIG. 11, it is preferable to provide the slit in the circumferential direction or the axial direction of the sheet-shaped body or the cylindrical body of the coating member 200A consisting of the copper or copper alloy forming the coat 200. According to such configuration, in the location of the slit, the outer circumferential side and the inner circumferential side of the coating member 200A are penetrated such that it is possible to remove gas and bubbles of the air and the like existing between the coating member 200A and the wall (in this case, the inner circumferential surface 100a) of the joint member 100. In addition, due to the slit, it is possible to eliminate the distortion that occurs during the heating in the metallic bond.

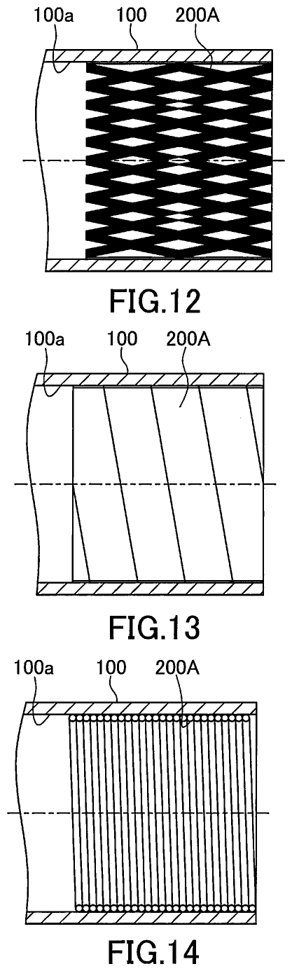

Furthermore, as shown in FIG. 12, regarding the joint member 100 according to the present invention, it is preferable that the coating member 200A consisting of the copper or copper alloy forming the coat 200 is the net-shaped body and is arranged in the state of being rounded in the C shape or arranged in the annular shape. According to such configuration, in the case in which the coating member 200A is arranged in the state of being rounded in the C shape, the coating member 200A is held by the end portion of the joint member 100 due to the elastic force of the coating member 200A, and in the case in which the coating member 200A is arranged in the annular shape, the coating member 200A is held by the elastic force for maintaining shape to the direction contracting inwardly in the diameter direction due to the elastic deformation expanding outwardly in the diameter direction or by the elastic force for maintaining shape to the direction expanding outwardly in the diameter direction due to the elastic deformation contracting inwardly in the diameter direction, in response to the arrangement location such that for example, it is possible to save the trouble of holding the coating member 200A with respect to the arrangement location by a spot welding or the like and it is easy to arrange the coating member 200A. Also, the coating member 200A has the net-shaped holes, that penetrate the outer circumferential side and the inner circumferential side of the coating member 200A, throughout the coating member 200A such that it is possible to remove gas and bubbles of the air and the like existing between the coating member 200A and the wall (in this case, the inner circumferential surface 100a) of the joint member 100. In addition, due to the net-shaped holes, it is possible to eliminate the distortion that occurs during the heating in the metallic bond.

Also, regarding the joint member 100 as the refrigerant pipe according to the present invention, it is preferable that the coating member 200A consisting of the copper or copper alloy forming the coat 200 is the band-shaped body with the rectangular cross section as shown in FIG. 13 or the band-shaped body with the circular cross section as shown in FIG. 14 and is spirally arranged along the axial direction. According to such configuration, the band-shaped coating member 200A is held by the end portion of the joint member 100 due to the elastic force of the coating member 200A such that it is possible to save the trouble of holding the coating member 200A with respect to the arrangement location by a spot welding or the like and it is easy to arrange the coating member 200A. Also, the coating member 200A is formed with the fine gaps spirally penetrating the outer circumferential side and the inner circumferential side thereof such that the gas and bubbles of the air and the like existing between the coating member 200A and the wall of the joint member 100 (in this case, the inner circumferential surface 100a) can be removed through the gaps. In addition, due to the fine gaps, it is possible to eliminate the distortion that occurs during the heating in the metallic bond.

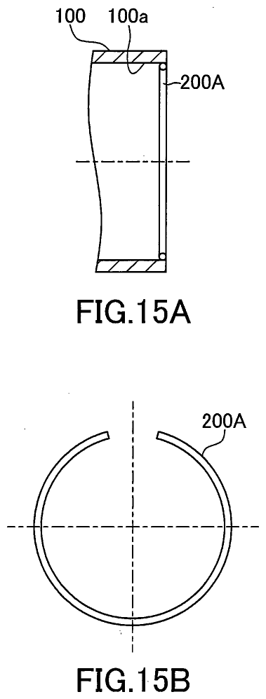

Furthermore, regarding the joint member 100 as the refrigerant pipe according to the present invention, as shown in FIG. 15A and FIG. 15B, it is preferable that the coating member 200A consisting of the copper or copper alloy forming the coat is the ring-shaped body with the C shape or annular shape and a plurality of coating members 200A being adjacent to each other are arranged along the axial direction. According to such configuration, in the case in which the ring-shaped coating member 200A is arranged in the state of being rounded in the C shape, the coating member 200A is held by the end portion of the joint member 100 due to the elastic force of the corresponding coating member 200A, and in the case in which the coating member 200A is arranged in the annular shape, the coating member 200A is held by performing the plastic processing expanding outwardly in the diameter direction or performing the plastic processing contracting inwardly in the diameter direction in response to the arrangement location such that for example, it is possible to save the trouble of holding the coating member 200A with respect to the arrangement location by a spot welding or the like and it is easy to arrange the coating member 200A. Also, the fine gaps penetrating the inner circumferential side and the outer circumferential side are formed between the adjacent multi-layer ring-shaped coating members 200A such that the gas and bubbles of the air and the like existing between the adjacent multi-layer ring-shaped coating member 200A and the wall of the joint member 100 (in this case, the inner circumferential surface 100a) can be removed through the gaps. In addition, due to the multi-layer fine gaps, it is possible to eliminate the distortion that occurs during the heating in the metallic bond.

Also, regarding the joint member 100 according to the present invention, it is preferable that the coating member 200A consisting of the copper or copper alloy forming the coat is the wire-shaped body and arranged in the state of being rounded in C shape or annular shape. Also, the figure showing the wire-shaped coating member 200A is almost the same with FIG. 15 showing the ring-shaped coating member 200A such that the figure is omitted for convenience. According to such configuration, in the case in which the wire-shaped coating member 200A is arranged in the state of being rounded in the C shape, the coating member 200A is held by the end portion of the refrigerant pipe due to the elastic force of the corresponding coating member 200A, and in the case in which the coating member 200A is arranged in the annular shape, the coating member 200A is held by performing the plastic processing to expand outwardly in the diameter direction or by performing the plastic processing to contract inwardly in the direction in response to the arrangement location thereof such that for example, it is possible to save the trouble of holding the coating member 200A with respect to the arrangement location by a spot welding or the like and it is easy to arrange the coating member 200A.

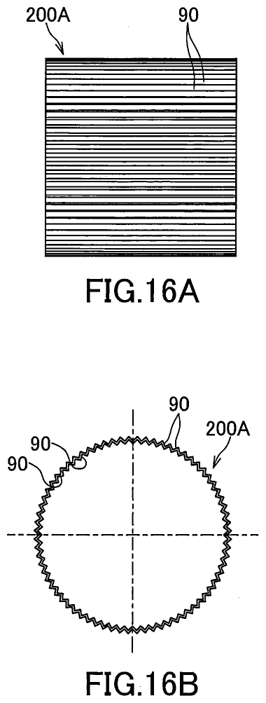

Regarding the joint member 100 as the refrigerant pipe according to the present invention, as shown in FIG. 16A and FIG. 16B, it is preferable that the coating member 200A consisting of the copper or copper alloy forming the coat is formed in the annular shape, and the coating member 200A is formed with the surface of the cross section orthogonal to the axial direction in the uneven shape along the circumferential direction. That is, the coating member 200A may include a concave-convex portion 90 on the inner circumferential surface or/and the outer circumferential surface. In this case, the concave-convex portion may be widely applied with various shapes such as a semicircular shape, a chevron shape, a rectangular shape or the like. By configuring the coating member 200A in this manner, the coating member 200A is held by the elastic force for maintaining shape to the direction contracting inwardly in the diameter direction due to the elastic deformation expanding outwardly in the diameter direction or by the elastic force for maintaining shape to the direction expanding outwardly in the diameter direction due to the elastic deformation contracting inwardly in the diameter direction, in response to the arrangement location such that for example, it is possible to save the trouble of holding the coating member 200A with respect to the arrangement location by a spot welding or the like and it is easy to arrange the coating member 200A.

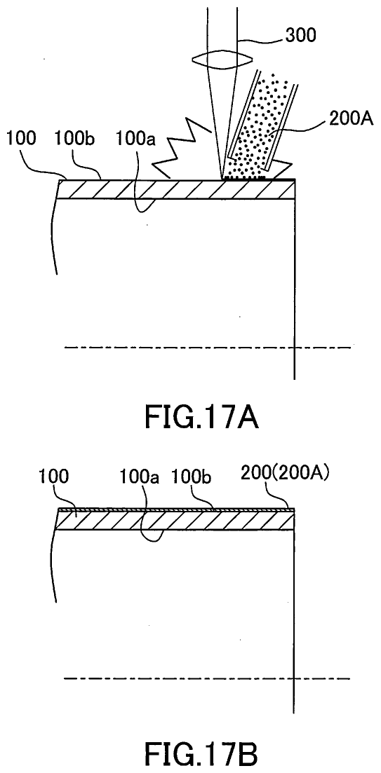

Furthermore, the joint member 100 as the refrigerant pipe of the present invention is the refrigerant pipe consisting of the stainless steel, and as shown in FIG. 17A and FIG. 17B, the coat 200 consisting of the copper or copper alloy may be formed by the laser irradiation using a laser 300 on the outer circumferential surface 100b (or the inner circumferential surface 100a) in the end portion on at least one side in the longitudinal direction. According to such configuration, it is possible to remove the oxide coat by the laser irradiation and directly form the coat 200 by spraying the power-like coating member 200A consisting of the copper or copper alloy with respect to the outer circumferential surface 100b (or the inner circumferential surface 100a) of the joint member 100 such that it becomes easier to form the coat 200.

Hereinbefore, the manufacturing method of the refrigerant pipe (joint member 100) is the manufacturing method of the joint member 100 consisting of the stainless steel, and is provided to heat copper or copper alloy to a temperature above a solidus temperature to cause the copper or the copper alloy into a semi-molten state in an environment in which an oxide coat is removable so as to form a coat of copper or copper alloy with respect to an inner circumferential surface 100a or an outer circumferential surface 100b in an end portion on at least one side of a longitudinal direction of the joint member 100. According to such manufacturing method of the joint member 100, even in the case in which the joint member 100 itself consists of the material including the stainless steel, the coat of copper or copper alloy is formed on the inner circumferential surface or the outer circumferential surface of the connecting end portions such that it is easy to perform the connection by using brazing.

Hereinbefore, the connection structure for the described refrigerant pipe (joint member 100) is the connection structure for the joint member 100 where the joint member 100 (first refrigerant pipe) and the refrigerant pipe 60 (second refrigerant pipe) are connected by brazing, and it is preferable that the joint member 100 made of the stainless steel is formed with the coat 200 of copper or copper alloy by metallic bond on the inner circumferential surface 100a (or the outer circumferential surface 100b) in the end portion thereof at the refrigerant pipe 60 side, and the refrigerant pipe 60 consists of the copper or the copper alloy (or the coat 200 of copper or copper alloy by metallic bond is formed on the inner circumferential surface 100a or the outer circumferential surface 100b of the end portion thereof at the joint member 100 side). According to such connection structure of the joint member 100, even in the case in which the joint member 100 (first refrigerant pipe) consists of the stainless steel, the coat 200 of the copper or copper alloy formed by metallic bond is formed on the inner circumferential surface 100a or the outer circumferential surface 100b in the end portion at the refrigerant pipe 60 (second refrigerant pipe) side such that it is easy to realize the connection with the second refrigerant pipe, as the connection target thereof, which is made of copper or copper alloy, or including the coat of copper or copper alloy formed by the metallic bond on the outer circumferential surface 60a or the inner circumferential surface 60b in the end portion at the first refrigerant pipe side.

Hereinbefore, the slide-type switching valve 10 as the described valve device is the valve device in which the joint member 11 is connected to the valve housing 1 as the valve main body, and it is preferable that any of the above-described refrigerant pipe (joint member 100) is used at the joint member. According to such slide-type switching valve 10, similar to the above-described joint member 100, even in the case in which the joint member 100 consists of the stainless steel, the coat 200 of copper or copper alloy is formed on the inner circumferential surface 100a or the outer circumferential surface 100b of the end portion of this joint member 100 such that it is easy to perform the connection with respect to the refrigerant pipe as the connection target by using brazing. In addition, the same effects as that of any of the above-described joint members 100 can be achieved.

The best configurations, method and the like for implementing the present invention are disclosed hereinbefore, however, the present invention is not limited thereto. That is, the present invention is shown in drawing and described according to the specific embodiment, however, various modifications in the shapes, materials, amounts, and other configurations in detail with respect to the above-described embodiment can be made without departing from the spirit of the present invention by the person with ordinary skill in the art. Therefore, the descriptions that limit the shapes, materials and the like disclosed above are provided as examples to facilitate understanding of the present invention, and they are not meant to limit the present invention such that the descriptions in the names of members where some or all of the limitations of these shapes, materials and the like are excluded should also be included in the scope of the present invention.

### REFERENCE SIGNS LIST

1 valve housing (valve main body)
11 cylindrical portion
12 cap portion
21 packing
22 fixed circular plate
23 leaf spring
3 connection plate
4 valve seat
5 valve body
10 slide-type switching valve
100 joint member (refrigerant pipe, first refrigerant pipe)
100a inner circumferential surface
100b outer circumferential surface
100c end surface
200 coat
200A coating member
200A1 notch
200A2 flange portion
200A3 end portion
200A4 end portion
60 refrigerant pipe (second refrigerant pipe)
60a outer circumferential surface
60b inner circumferential surface
60c end surface
70 fillet
80 slit
81 slit
90 uneven portion
300 laser

1. A refrigerant pipe consisting of stainless steel, wherein a coat of copper or copper alloy by a metallic bond is formed on an inner circumferential surface or an outer circumferential surface in an end portion on at least one side in a longitudinal direction.

2. The refrigerant pipe according to claim 1, wherein a coating member consisting of the copper or the copper alloy forming the coat is a sheet-shaped body and is arranged in a state of being rounded in a C shape.

3. The refrigerant pipe according to claim 1, wherein a coating member consisting of the copper or the copper alloy forming the coat is an annular cylindrical body.

4. The refrigerant pipe according to claim 2, wherein a slit is provided in a circumferential direction or an axial direction of the coating member consisting of the copper or the copper alloy forming the coat.

5. The refrigerant pipe according to claim 1, wherein a coating member consisting of the copper or the copper alloy forming the coat is a net-shaped body and is arranged in an annular shape or in a state of being rounded in a C shape.

6. The refrigerant pipe according to claim 1, wherein a coating member consisting of the copper or the copper alloy forming the coat is a band-shaped body with a cross section in a circular shape or a rectangular shape, and is spirally arranged along an axial direction.

7. The refrigerant pipe according to claim 1, wherein a coating member consisting of the copper or the copper alloy forming the coat is a ring-shaped body in a C shape or an annular shape, and a plurality of the coating member are provided along an axial direction so as to be adjacent to each other.

8. The refrigerant pipe according to claim 1, wherein a coating member consisting of the copper or the copper alloy forming the coat is a wire-shaped body, and is arranged in an annular shape or in a state of being rounded in a C shape.

9. The refrigerant pipe according to claim 2, wherein in a coating member consisting of the copper or the copper alloy forming the coat, a surface of a section orthogonal to an axial direction is formed in an uneven shape along a circumferential direction.

10. The refrigerant pipe according to claim 1, wherein the coat is formed to extend to an end surface in the end portion at the one side.

11. A manufacturing method of a refrigerant pipe that consists of stainless steel, comprising heating copper or copper alloy to a temperature above a solidus temperature to cause the copper or the copper alloy into a semi-molten state in an environment in which an oxide coat is removable so as to form a coat of copper or copper alloy with respect to an inner circumferential surface or an outer circumferential surface in an end portion on at least one side of a longitudinal direction of the refrigerant pipe.

12. The manufacturing method of a refrigerant pipe according to claim 11, wherein the environment in which an oxide coat is removable is a hydrogen reduction furnace.

13. The manufacturing method of a refrigerant pipe according to claim 11, wherein the coat of copper or copper alloy is formed by laser irradiation.

14. A connection structure for refrigerant pipes where a first refrigerant pipe and a second refrigerant pipe are connected by brazing,
wherein the first refrigerant pipe consists of stainless steel, and a coat of copper or copper alloy by metallic bond is formed on an inner circumferential surface or an outer circumferential surface of an end portion of the first refrigerant pipe at the second refrigerant pipe side, and
the second refrigerant pipe consists of the copper or the copper alloy, or the coat of copper or copper alloy by metallic bond is formed on an inner circumferential surface or an outer circumferential surface of an end portion of the second refrigerant pipe at the first refrigerant pipe side.

15. The connection structure for refrigerant pipes according to claim 14, wherein in the first refrigerant pipe, the coat is formed to extend to an end surface in an end portion of the first refrigerant pipe at the second refrigerant pipe side and, in the second refrigerant pipe, in a case in which the second refrigerant pipe does not consist of the copper or the copper alloy, the coat is formed to extend to an end surface of an end portion of the second refrigerant pipe at the first refrigerant pipe side.

16. A valve device, comprising a valve main body to which a joint member is connected, wherein the refrigerant pipe according to claim 1 is used at the joint member.
